(19) United States
(12) Patent Application Publication
(10) Pub. No.: US 2021/0185910 A1
(43) Pub. Date: Jun. 24, 2021

(54) GRASS MOWER

(71) Applicant: HONDA MOTOR CO., LTD., Tokyo (JP)

(72) Inventors: Masashi Takeichi, Wako-shi (JP); Kenta Kawanishi, Wako-shi (JP)

(21) Appl. No.: 17/117,493

(22) Filed: Dec. 10, 2020

(30) Foreign Application Priority Data
Dec. 19, 2019 (JP) 2019-229377

(51) Int. Cl. A01D 34/73; A01D 34/78; A01D 34/64; A01D 34/00

(52) U.S. Cl. CPC A01D 34/733; A01D 34/78; A01D 2101/00; A01D 34/008; A01D 34/64

(57) ABSTRACT

A grass mower includes: a main body; a working unit driving motor (drive source) mounted on the main body; an output shaft that projects downward from the working unit driving motor and is rotated by the working unit driving motor; a mowing blade disk mounted to the output shaft; and an upper guard provided to cover the output shaft, the output shaft being between the mowing blade disk and the main body, wherein the upper guard includes a cutout portion for exposing the mowing blade disk at a rear end in the traveling direction of the main body.

### INCORPORATION BY REFERENCE

The present application claims priority under 35 U.S.C. § 119 to Japanese Patent Application No. 2019-229377 6 filed on Dec. 19, 2019. The content of the application is incorporated herein by reference in its entirety.

### BACKGROUND OF THE INVENTION

### Field of Invention

The present invention relates to a grass mower.

### Description of the Related Art

In recent years, working machines such as lawn mowers or grass mowers have been known in which a plurality of mowing blades are attached to a mowing blade disk that is driven by a motor and rotates substantially horizontally.

As such working machines, autonomous traveling working machines capable of autonomously traveling, namely robot working machines have been developed.

Such a working machine includes, for example, an output shaft driven by a motor, a mowing blade disk attached to the output shaft, and a plurality of mowing blades formed on the outer peripheral edge of the mowing blade disk, and drives a motor to rotationally drive a mowing blade disk via the output shaft, thereby rotating the mowing blades and mowing grass or lawn (see, for example, Japanese Patent Laid-Open No. 2016-135099).

However, although the technique in Japanese Patent Laid-Open No. 2016-185099 does not cause much problem in cases of mowing a short grass, for example, the technique has a problem in cases of mowing long grass, in which the rotational load of mowing blade disk increases when a mowing blade hits long grass, and the rotational load further increases if long grass wind around the output shaft of the motor.

In such a case, it is possible to increase the size of the motor to increase the output to cope with mowing long grass, but this increases the size of the working machine itself.

Further, when a load due to mowing of long grass is detected, it is also possible to lower the traveling speed of the working machine to cope with it, but it is not possible to prevent the grass from winding around the output shaft of the motor.

The present invention has been made in view of the above-mentioned point, and an object of the present invention is to provide a grass mower which can easily mow long grass.

### SUMMARY OF THE INVENTION

In order to achieve the above object, a grass mower according to a first aspect of the present invention includes: a main body; a drive source mounted on the main body; an output shaft that projects downward from the drive source and that is rotated by the drive source; a mowing blade disk mounted to the output shaft; and an upper guard provided to cover the output shaft, the output shaft being between the mowing blade disk and the main body, wherein the upper guard includes a cutout portion for exposing the mowing blade disk at a rear end in the traveling direction of the main body.

A grass mower according to a second aspect of the present invention has the above configuration, wherein: the upper guard includes an engagement portion to be engaged with a housing on a first side of the upper guard, the housing supporting the drive source; and the upper guard is engaged with and fixed to the housing at the engagement portion, and is bolt-fixed to the housing on a second side of the upper guard.

A grass mower according to a third aspect of the present invention has the above configuration, wherein the mowing blade disk includes a plurality of mowing blades on the outer periphery of the mowing blade disk.

A grass mower according to a fourth aspect of the present invention has the above configuration, wherein the front end of the upper guard in the traveling direction of the main body is located rearward of the mowing blades.

A grass mower according to a fifth aspect of the present Invention has the above configuration, wherein: each of the mowing blades is rotatably attached to an attachment pin provided on the mowing blade disk; and the upper guard includes a guard portion that avoids the attachment pin.

### Advantageous Effects of Invention

According to an aspect of the present invention, the upper guard is provided to guide the grass mown by the mowing blade disk, toward the upside of the upper guard, and this can prevent the mown grass from entering between the mowing blade disk and the output shaft, and can prevent the grass from winding around the output shaft. Further, since the cutout portion exposes the rear portion of the mowing blade disk, the mown grass can be efficiently discharged rearward. As a result, even in a case of mowing high or long grass, it is possible to prevent increase of the load to the mowing blade disk, and to mow long grass without increasing the output of the drive source.

### BRIEF DESCRIPTION OF THE DRAWINGS

FIG. 1 is a schematic configuration diagram showing an embodiment of a grass mower according to the present invention;

FIG. 2 is a cross-sectional view showing a working unit of this embodiment;

FIG. 3 is a plan view showing a working unit of this embodiment;

FIG. 4 is a plan view showing an upper guard of this embodiment; and

FIG. 5 is an explanatory diagram showing a state when mowing is performed according to this embodiment.

### DETAILED DESCRIPTION OF THE PREFERRED EMBODIMENTS

Embodiments of the present invention are described below with reference to the drawings.

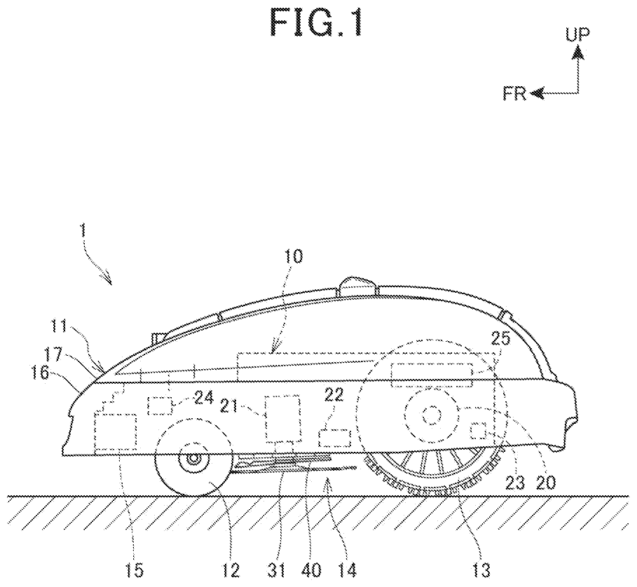

FIG. 1 is a schematic configuration diagram showing an embodiment of a grass mower according to the present invention.

The grass mower according to this embodiment is, for example, an autonomous traveling grass mower that mows grass while autonomously traveling in a predetermined mowing area partitioned by an area wire which is a wire for detecting a boundary.

The grass mower 1 includes a main body 10 having a traveling function and the like, and a vehicle body cover 11 that covers the main body 10. Left and right front wheels 12 that can be steered to the left and right are provided at the lower front portion of the main body 10, left and right rear wheels 13 functioning as drive wheels are provided at the lower rear portion of the main body 10, and a working unit 14 is provided at the lower center portion of the main body 10. In addition, a terminal unit 15 that is electrically connected to a charging station (not shown) is provided on the front portion of the grass mower 1.

The main body 10 is also an electric and electronic unit including: left and right traveling motors 20 that individually drive the left and right rear wheels 13; a working unit driving motor 21 as a drive source for driving the working unit 14; a battery 22 that functions as a power supply for supplying operation power to each unit of the grass mower 1; a wheel speed sensor 23 for detecting the rotational speeds of the left and right rear wheels 13 which are driving wheels; a sensor unit 24 for detecting the area wire and the like to detect a position of the grass mower 1; and a control unit 25 that controls each unit of the grass mower 1.

The control unit 25 has a CPU (Central Processing Unit) (not illustrated) and a memory (not illustrated) that stores programs and various data. By executing, by the CPU, the programs stored in the memory, the control unit 25 controls the driving of the traveling motor 20 to control the traveling of the grass mower 1, and controls the driving of the working unit driving motor 21 to perform the predetermined work. The working unit 14 of this embodiment, is a mowing blade disk 31 provided with a mowing blade 30, and the mowing blade disk 31 is rotationally driven to perform mowing work.

The control unit 25 identifies the position of the grass mower 1 based on the detection results of the wheel speed sensor 23 and the sensor unit 24, and controls the traveling of the grass mower 1 based on the identified position. This allows the grass mower 1 to travel to appropriately mow the grass in the grass mowing area 4, and to move to the charging station after finishing the mowing work.

Here, for the configuration of the main body 10 excluding the terminal unit 15, configurations of known robot grass mowers can be widely applied. For example, for the technique to identify the grass mowing area, charging station, current position, and the like, a magnetic sensor for detecting the area wire may be applied as the sensor unit 24, a position detection device such as GPS or a gyro sensor may be applied as the sensor unit 24, and an image recognition technique using a camera, or the like may be applied.

The vehicle body cover 11 includes a main cover 16 that covers at least the front portion of the main body 10, and a top cover 17 that is connected to the main cover 56 from above. The main cover 56 is formed as a cover that covers the front, rear, left, and right of the main body 20 and opens a part of the main body 10 upward, and is made of a resin material. Further, the top cover 17 is formed as a cover that covers a region of the main cover 16 in which a part of the main body 10 is opened, and is made of a resin material. These covers 16 and 17 function as a protective cover that prevents rainwater, dust, or the like from adhering to the main body 10 and a decorative cover that improves appearance.

Note that the vehicle body cover 11 is not limited to being made of resin. Further, when the grass mower 1 has a small size, the main cover 16 and the top cover 17 may be integrally formed.

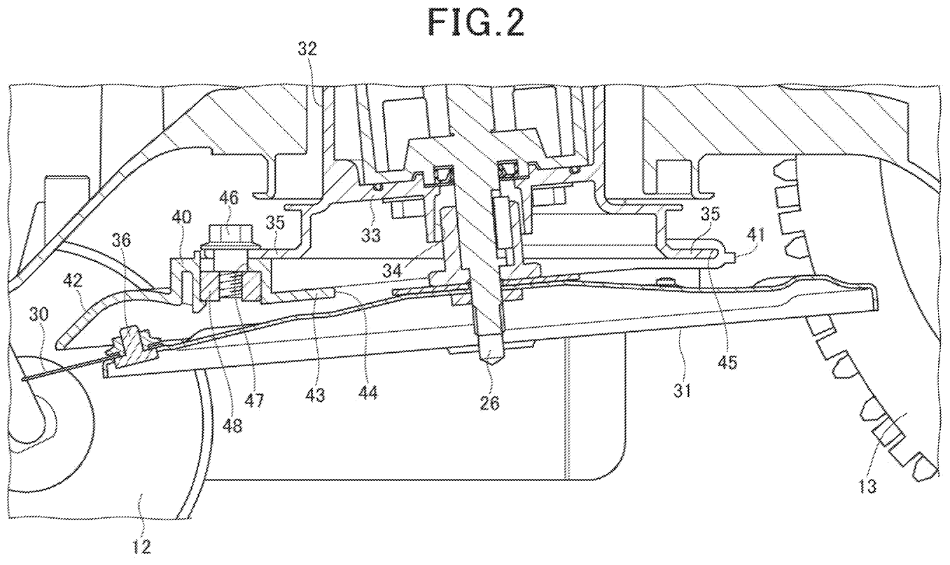

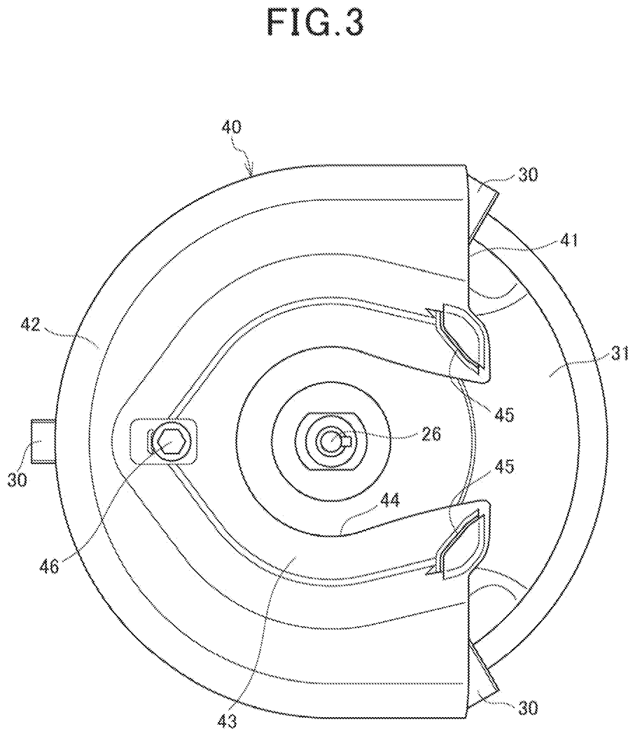

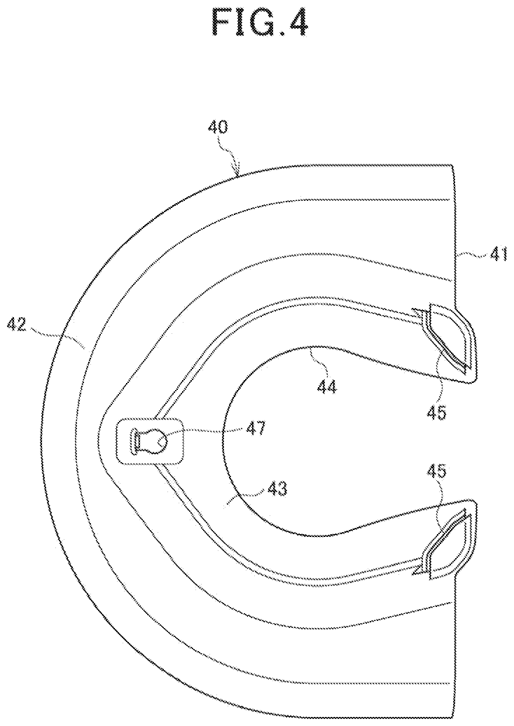

FIG. 2 is a schematic cross-sectional view showing details of the working unit. FIG. 3 is a plan view of the working unit. FIG. 4 is a plan view of an upper guard.

As shown in FIG. 2, the main body 10 includes a motor housing 32 in which the working unit driving motor 21 is housed. The motor housing 32 is disposed so as to be inclined with respect to the main body 10 so that the front is located below.

A motor support portion 33, which supports the lower surface of the working unit driving motor 21, is provided at the lower end portion of the motor housing 32. A shaft opening 34, through which an output shaft 26 of the working unit driving motor 21 penetrates, is provided at a substantially central portion of the motor support portion 33, A support flange 35 is formed on the outer peripheral side of the lower end of the motor support portion 33 so as to extend outward.

The working unit driving motor 21 is supported by the motor housing 32, and the output shaft 26 of the working unit driving motor 21 projects below the motor housing 32 through the shaft opening 34. The mowing blade disk 31 is mounted to the lower end portion of the output shaft 26.

Attachment pins 36 projecting upward are provided near, the outer periphery of the mowing blade disk 31. The attachment pins 36 are provided at three locations in the circumferential direction of the mowing blade disk 31 at predetermined intervals.

One end portion of the mowing blade 30 is rotatably attached to each attachment pin 36.

Then, the working unit driving motor 21 is driven to rotationally drive the mowing blade disk 31 via the output shaft 26. This causes the mowing blades 30 to rotationally move about the attachment pins 36 and to be kept projecting to the outer peripheral side of the mowing blade disk 31 due to the centrifugal force of the mowing blade disk 31. This then causes the mowing blades 30 to mow the grass.

Further, as shown in FIGS. 2 and 3, in this embodiment, an upper guard 40 located above the mowing blade disk 31 is attached to the lower end of the motor housing 32.

As shown in FIGS. 2 to 4, the front side of the upper guard 40 with respect to the main body 10 is formed in an arc shape along the outer shape of the mowing blade disk 31, and both sides of the upper guard 40 are linearly formed so as to extend in the front-rear direction of the main body 10.

The rear end of the upper guard 40 has a cutout portion 41 formed substantially to the middle in the radial direction of the mowing blade disk 31, so that the rear of the mowing blade disk 31 is exposed. As a result, a part of the rear of the mowing blade disk 31 is not covered by the upper guard 40 and is kept exposed to the outside. The upper guard 40 is formed in a substantially U shape in plan view as a whole.

A guard portion 42 is formed on the outer peripheral side of the upper guard 40. The guard portion 42 has a shape that bulges upward to avoid the attachment pins 36 of the rotating mowing blade disk 31.

A flat plate portion 43 is formed inside the guard portion 42 of the upper guard 40, and a recessed cutout portion 44 is formed in the flat plate portion 43 to avoid the output shaft 26 of the working unit driving motor 21.

Engagement cutouts 40, which engage with the support flange 35 of the motor housing 32, are formed at the inner corners between the cutout portion 41 and the recessed cutout portion 44 of the upper guard 40.

Further, a fixing hole 47 for inserting a fixing bolt 46 for fixing the upper guard 40 to the motor housing 32 is formed on the front side of the upper guard 40 and at the boundary portion between the guard portion 42 and the flat plate portion 43.

Further, in this embodiment, the front end portion of the guard portion 42 is positioned rearward in the front-rear direction by several mm to several tens of mm, from the position where each of the mowing blades 30 projects most forward. Further, the guard portion 42 is positioned such that the gap between the front end portion and the mowing blades 30 is several mm to several tens mm in the up-down direction. If the gap between the front end portion and the mowing blades 30 is too small, the grass may clog the gap between the mowing blade disk 31 and the upper guard 40.

The front-rear direction position and the up-down direction position of the guard portion 42 with respect to each of the mowing blades 30 are not limited to the above-described dimensions, and can be appropriately adjusted according to the thickness or length of the grass to be mown.

The upper guard 40 is engaged with the support flange 35 of the motor housing 32 at the engagement cutout 45, and then is fixed to the lower end of the motor housing 32 with the fixing bolt 46, which is inserted into the fixing hole 47, and the fixing nut 48, which are tightened together. In this way, it is possible that the upper guard 40 is engaged at its engagement cutout 45 with the support flange 35 of the motor housing 32 and is fixed with the fixing bolt 46, to be easily attached to the motor housing 32.

Next, how this embodiment works is described below.

In mowing grass, the working unit driving motor 21 is first driven to rotationally drive the mowing blade disk 31 via the output shaft 26. This causes the mowing blades 30 to rotationally move about the attachment pins 36 and to be kept projecting to the outer peripheral side of the mowing blade disk 31 due to the centrifugal force of the mowing blade disk 31. This then causes the mowing blades 30 to mow the grass.

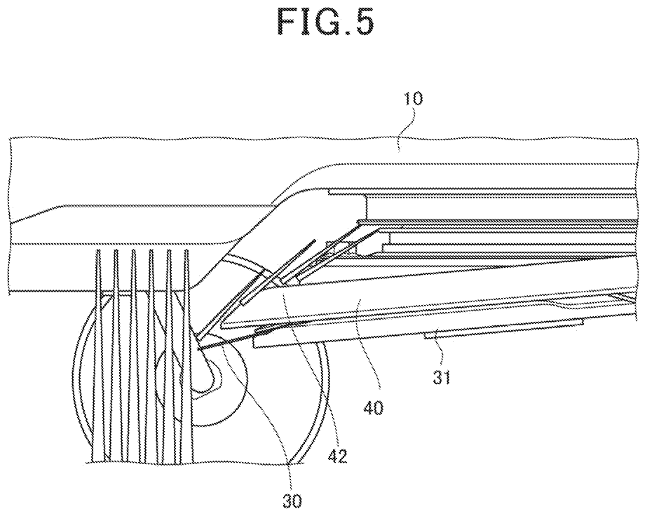

FIG. 5 is an explanatory diagram that shows a state where mowing is performed.

As shown in FIG. 5, since the upper guard 40 is provided above the mowing blade disk 31, the grass mown by the mowing blades 30 is conveyed to the upper side of the guard portion 42 of the upper guard 40. The mown grass is thus conveyed above the upper guard 40, so that the mown grass does not enter between the mowing blade disk 31 and the upper guard 40.

The grass guided to the upper side of the upper guard 40 is sequentially conveyed to the rear of the upper guard 40 and dropped downward from the rear end of the upper guard 40 when the working machine continues to travel to mow.

At this time, since the mowing blade disk 31 is exposed at the rear end, the mown grass can be easily discharged. Further, since the upper guard 40 is formed so as to cover the output shaft 26 part, it is possible to prevent grass from entering the output shaft 26 part and causing problems such as grass winding.

As described above, in this embodiment, a grass mower includes: a main body 10; a working unit driving motor 21 (drive source) mounted on the main body 10; an output shaft 26 that projects downward from the working unit driving motor 21 and is rotated by the working unit driving motor 21; a mowing blade disk 31 mounted to the output shaft 26; and an upper guard 40 provided to cover the output shaft 26, the output shaft 26 being between the mowing blade disk 31 and the main body 10, wherein the upper guard 40 includes a cutout portion 41 for exposing the mowing blade disk 31 at a rear end in the traveling direction of the main body 10.

Accordingly, the upper guard 40 is provided to guide the grass mown by the mowing blades 30 of mowing blade disk 31, toward the upside of the upper guard 40, and this can prevent the mown grass from entering between the mowing blade disk 31 and the output shaft 26, and can prevent the grass from winding around the output shaft 26. Further, since the cutout portion 41 exposes the rear portion of the mowing blade disk 31, the mown grass can be efficiently discharged rearward.

As a result, even in a case of mowing high or long grass, it is possible to prevent increase of the load to the mowing blade disk 31, and to mow long grass without increasing the output of the working unit driving motor 21.

Further, in this embodiment, the upper guard 40 includes an engagement cutout 45 (engagement portion) on a first side, to be engaged with a motor housing 32 (housing) that supports the working unit driving motor 21 (drive source), and the upper guard 40 is engaged with and fixed to the motor housing 32 at the engagement cutout 45 and is bolt-fixed to the motor housing 32 by a fixing bolt 46 on a second side of the upper guard 40.

As a result, engaging the engagement cutout 45 with the motor housing 32, and bolt-fixing by the fixing bolt 46 enables the upper guard 40 to be easily attached to the motor housing 32.

Further, in this embodiment, the mowing blade disk 31 includes a plurality of mowing blades 30 on its outer periphery.

This makes it possible to mow the grass with the mowing blades 30 provided on the mowing blade disk 31.

Further, in this embodiment, the front end of the upper guard 40 in the traveling direction of the main body 10 is located rearward of the mowing blades 30.

As a result, the mown grass can be guided toward the upside of the upper guard 40.

Further, in this embodiment, each of the mowing blades 30 is rotatably attached to an attachment pin 36 provided on the mowing blade disk 31, and the upper guard 40 includes a guard portion 42 that avoids the attachment pins 36.

Accordingly, long grass can be mown without hindering the rotating operation of the mowing blades 30.

The above embodiment is merely an embodiment of the present invention, and can be modified and applied in any way without departing from the scope of the present invention.

For example, in the above-described embodiment, a grass mower that mows relatively long grass has been described, but the present invention is not limited to this, and can be applied as a lawn mower that mows relatively short grass (lawn).

### REFERENCE SIGNS LIST

1 grass mower

10 main body

11 vehicle body cover

12 front wheel

13 rear wheel

14 working unit

21 working unit driving motor

26 output shaft

30 mowing blade

31 mowing blade disk

32 motor housing

35 support flange

36 attachment pin

40 upper guard

41 cutout portion

42 guard portion

43 flat plate portion

44 recessed cutout portion

What is claimed is:

1. A grass mower comprising:
a main body;
a drive source mounted on the main body;
an output shaft that projects downward from the drive source and that is rotated by the drive source;
a mowing blade disk mounted to the output shaft; and
an upper guard provided to cover the output shaft, the output shaft being between the mowing blade disk and the main body,
wherein the upper guard includes a cutout portion for exposing the mowing blade disk at a rear end in a traveling direction of the main body.

2. The grass mower according to claim 1, wherein
the upper guard includes an engagement portion to be engaged with a housing on a first side of the upper guard, the housing supporting the drive source, and
the upper guard is engaged with and fixed to the housing at the engagement portion, and is bolt-fixed to the housing on a second side of the upper guard.

3. The grass mower according to claim 1, wherein
the mowing blade disk includes a plurality of mowing blades on an outer periphery of the mowing blade disk.

4. The grass mower according to claim 3, wherein
a front end of the upper guard in the traveling direction of the main body is located rearward of the mowing blades.

5. The grass mower according to claim 3, wherein
each of the mowing blades is rotatably attached to an attachment pin provided on the mowing blade disk, and
the upper guard includes a guard portion that avoids the attachment pin.
